(19) United States
(12) Patent Application Publication
(10) Pub. No.: US 2009/0252102 A1
(43) Pub. Date: Oct. 8, 2009

(54) METHODS AND SYSTEMS FOR A MOBILE, BROADBAND, ROUTABLE INTERNET

(76) Inventors: Scott Y. Seidel, Fairfax, VA (US); Peter Atwal, Longwood, FL (US)

Correspondence Address: STRATEGIC PATENTS P.C.., C/O PORTFOLIOIP, P.O. BOX 52050, MINNEAPOLIS, MN, 55402, US

(21) Appl. No.: 12/394,860

(22) Filed: Feb. 27, 2009

Related U.S. Application Data
(60) Provisional application No. 61/031,960, filed on Feb. 27, 2008.
(60) Provisional application No. 61/042,431, filed on Apr. 4, 2008.
(60) Provisional application No. 61/042,442, filed on Apr. 4, 2008.
(60) Provisional application No. 61/074,930, filed on Jun. 23, 2008.
(60) Provisional application No. 61/082,618, filed on Jul. 22, 2008.
(60) Provisional application No. 61/082,642, filed on Jul. 22, 2008.
(60) Provisional application No. 61/086,242, filed on Aug. 5, 2008.
(60) Provisional application No. 61/084,738, filed on Jul. 30, 2008.
(60) Provisional application No. 61/084,773, filed on Jul. 30, 2008.
(60) Provisional application No. 61/094,394, filed on Sep. 4, 2008.
(60) Provisional application No. 61/094,546, filed on Sep. 5, 2008.
(60) Provisional application No. 61/118,232, filed on Nov. 26, 2008.
(60) Provisional application No. 61/094,584, filed on Sep. 5, 2008.
(60) Provisional application No. 61/094,591, filed on Sep. 5, 2008.
(60) Provisional application No. 61/094,594, filed on Sep. 5, 2008.
(60) Provisional application No. 61/094,611, filed on Sep. 5, 2008.
(60) Provisional application No. 61/095,298, filed on Sep. 8, 2008.
(60) Provisional application No. 61/095,310, filed on Sep. 9, 2008.
(60) Provisional application No. 61/094,183, filed on Sep. 4, 2008.
(60) Provisional application No. 61/094,203, filed on Sep. 4, 2008.
(60) Provisional application No. 61/094,279, filed on Sep. 4, 2008.
(60) Provisional application No. 61/094,294, filed on Sep. 4, 2008.
(60) Provisional application No. 61/094,231, filed on Sep. 4, 2008.
(60) Provisional application No. 61/094,247, filed on Sep. 4, 2008.
(60) Provisional application No. 61/094,310, filed on Sep. 4, 2008.
(60) Provisional application No. 61/103,106, filed on Oct. 6, 2008.
(60) Provisional application No. 61/111,384, filed on Nov. 5, 2008.
(60) Provisional application No. 61/112,131, filed on Nov. 6, 2008.
(60) Provisional application No. 61/121,169, filed on Dec. 9, 2008.

(51) Int. Cl. H04W 72/04; H04W 4/00

(52) U.S. Cl. 370/329; 370/338

(57) ABSTRACT

In embodiments of the present invention improved capabilities are described for forming a mobile ad hoc network having a plurality of wireless communication links connecting a plurality of wireless mobile nodes. The present invention may apply a dynamic spectrum awareness algorithm to facilitate effective utilization of the available communications spectrum in an environment of the mobile ad hoc network, support both delay-sensitive and delay-tolerant traffic types on the mobile ad hoc network, and provide a defined quality of communications service for both the delay-sensitive and the delay-tolerant traffic.

### CROSS-REFERENCE TO RELATED APPLICATIONS

This application claims the benefit of the following patent applications, each of which is hereby incorporated by reference in its entirety:

U.S. Provisional App. No. 61/031,960 filed Feb. 27, 2008; U.S. Provisional App. No. 61/042,431 filed Apr. 4, 2008; U.S. Provisional App. No. 61/042,442 filed Apr. 4, 2008; U.S. Provisional App. No. 61/074,930 filed Jun. 23, 2008; U.S. Provisional App. No. 61/082,618 filed Jul. 22, 2008; U.S. Provisional App. No. 61/082,642 filed Jul. 22, 2008; U.S. Provisional App. No. 61/086,242 filed Aug. 5, 2008; U.S. Provisional App. No. 61/084,738 filed Jul. 30, 2008; U.S. Provisional App. No. 61/084,773 filed Jul. 30, 2008; U.S. Provisional App. No. 61/094,394 filed Sep. 4, 2008; U.S. Provisional App. No. 61/094,546 filed Sep. 5, 2008; U.S. Provisional App. No. 61/118,232 filed Nov. 25, 2008; U.S. Provisional App. No. 61/094,584 filed Sep. 5, 2008; U.S. Provisional App. No. 61/094,591 filed Sep. 5, 2008; U.S. Provisional App. No. 61/094,594 filed Sep. 5, 2008; U.S. Provisional App. No. 61/094,611 filed Sep. 5, 2008; U.S. Provisional App. No. 61/095,298 filed Sep. 8, 2008; U.S. Provisional App. No. 61/095,310 filed Sep. 9, 2008; U.S. Provisional App. No. 61/094,183 filed Sep. 4, 2008; U.S. Provisional App. No. 61/094,203 filed Sep. 4, 2008; U.S. Provisional App. No. 61/094,279 filed Sep. 4, 2008; U.S. Provisional App. No. 61/094,294 filed Sep. 4, 2008; U.S. Provisional App. No. 61/094,231 filed Sep. 4, 2008; U.S. Provisional App. No. 61/094,247 filed Sep. 4, 2008; U.S. Provisional App. No. 61/094,310 filed Sep. 4, 2008; U.S. Provisional App. No. 61/103,106 filed Oct. 6, 2008; U.S. Provisional App. No. 61/111,384 filed Nov. 5, 2008; U.S. Provisional App. No. 61/112,131 filed Nov. 6, 2008; and U.S. Provisional App. No. 61/121,169 filed Dec. 9, 2008.

### FIELD OF THE INVENTION

The invention herein disclosed generally refers to networking, and more particularly to mobile networking.

### BACKGROUND

Existing wireless communications used in carrier-grade networks typically consist of a cell-based infrastructure where all mobile subscriber nodes must communicate directly with a network base station. As an alternative, wireless communications may utilize a mobile ad-hoc network, where any mobile node can communicate with any other node, either directly or through multiple hops across the network topology. However, existing mobile ad-hoc networks sometimes operate without any network infrastructure on a single fixed spectrum channel. Currently used techniques do not provide sufficient Quality of Service (QoS) needed to offer carrier-grade service in a heterogeneous broadband media environment containing both delay-sensitive (e.g., voice over Internet Protocol, VoIP) and delay-tolerant (e.g., internet browsing) traffic. Therefore, there exists a need to provide carrier-grade QoS in mobile networks.

### SUMMARY

In embodiments, the present invention may provide a mobile ad-hoc network (MANET) derived wireless Mobile Broadband Routable Internet (MBRI) communication platform capable of transporting multi-session Voice, Video, Data, and the like traffic with Carrier Grade Service Quality within the MBRI domain. The MBRI platform may be based on a MANET type network solution enhanced with a variety of new algorithms for routing and waveform transmission, that allows for cross communication stack layer optimization, information exchange, pay load prioritization along with an embedded neighborhood view in every communication node, and the like. As a result every node may perform at Carrier Grade Service level for each type of traffic offered resulting in an end-to-end carrier grade transport. The disclosure provided herein illustrates the interaction of the layers and routing algorithms resulting in carrier grade transport.

An MBRI network, and in particular the MBRI nodes in the network, in order to be capable of providing carrier grade service, may require unique algorithmic properties that ultimately manage radio spectrum efficiently and in a way that provides for warranted Service Level Agreements. These algorithmic properties may require a systematic approach to resolving the layer interactions between the routing, media access, and physical layers in such a way that all radio resources in a single node and between nodes, and between the MBRI and the wired network, are optimized to provide a fair and equitable allocation of spectrum in a non-competitive manner. This optimization may need to be implemented with maximum fairness, and with a high degree of predictability for successful peer to peer operation and deterministic outcome for data transfer operations between MBRI nodes within a single network. In particular, the MBRI routing layer may be required to link transparently to the Internet and be transparent to standard IP protocols such as OSPF and BGP4 and at the same time maintain the connectivity to/from the MBRI nodes. In addition, the MBRI routing layer may be required to transparently manage the dynamic changes in topology, dynamic births and deaths of the MBRI nodes, optimize route selection for peer to network and network to peer traffic, maintain dynamic route information for link routing, and the like.

The media access control (MAC) layer may be required to work seamlessly with the MBRI routing layer to inform the node of dynamic births and deaths in the network, to establish packet flows into and out of the MBRI, to rationalize fast path routing, and the like. In addition, the MAC layer may be required to optimize the use of spectrum and the physical layer resources to make peer to peer routing decisions including (1) scheduling spectrum for transmit and receive operations in a manner that is consistent with optimizing the ability of neighbors to simultaneously transmit in the MBRI network without interference with each other; (2) scheduling spectrum slots both in time and frequency, using adaptive methods such as link interference mitigation algorithms to reduce local interference and for using adaptive power algorithms to minimize neighborhood noise and interference; (3) maximizing the number of transmit opportunities in a neighborhood by using low power routes through a neighborhood; (4) dynamically adapting to link changes in topology during peer to peer operations; (5) dynamically adapting to node changes during peer to peer operations; (6) using adaptive data rate algorithms to select the highest modulation mode for peer to peer operations; (7) using statistical methods to increase or decrease spectrum slots in time and frequency depending upon traffic delay sensitivity, queue depths and application awareness data; (8) maintaining neighborhood physical layer information used for dynamic route selection and transmission decisions such as RSSI, SNR, Slot error rates, link costs and link interference mitigation statistics; and the like.

The physical layer may make available to the MAC layer and routing layer a dynamic waveform that offers spectrum allocation using multi-tiered bandwidth frequency allocations (i.e. sub-channels) and timeslot allocations, where the MAC layer may write or read payload data into or out of the timeslots and frequency allocations in a manner consistent with the needs of a node to transmit data to or receive data from a peer node. The physical layer may support multiple modulation modes and may dynamically concatenate the frequency and timeslot allocations in discrete step amounts based on the node's transmit and receive requirements and based on neighborhood negotiations for spectrum allocation. All three layers, that is to say the routing, MAC and physical layers, may be linked to perform their algorithmic duties asynchronously and then collectively to make routing decisions in the MBRI neighborhood on a per slot basis. In embodiments, there may be other dynamic protocols designed to maintain neighborhood health and routing table updates; to distribute time synchronization, environmental information, births and deaths of nodes; to pass queue depth information; and the like.

In embodiments, the present invention may operate a mobile ad hoc network, such as implemented as a method on the machine, as a system or apparatus as part of or in relation to the machine, or as a computer program product embodied in a computer readable medium executing on one or more of the machines. The present invention may form a mobile ad hoc network having a plurality of wireless communication links connecting a plurality of wireless mobile nodes, apply a dynamic spectrum awareness algorithm to facilitate effective utilization of the available communications spectrum in an environment of the mobile ad hoc network, support both delay-sensitive and delay-tolerant traffic types on the mobile ad hoc network, and provide a defined quality of communications service for both the delay-sensitive and the delay-tolerant traffic.

In embodiments, communication may be provided through link-by-link autonomous data rate selection, through unicast and multicast routing of data through the network, through peer-to-peer connections to selectively bypassing fixed communications network infrastructure, through dynamically adapting spectrum usage according to network and spectrum conditions, through enabling automatic re-transmission of loss-sensitive traffic, through transparent link and route maintenance during periods of spectrum adaptation, through scalability of network protocols for reliable operation with node densities and node mobilities of commercial wireless networks, and the like.

In embodiments, dynamically adapting spectrum usage according to network and spectrum conditions may include distributed decisions regarding local spectrum usage by individual wireless nodes. The connection of the mobile ad hoc network to a fixed network may enable backhaul load leveling. The connection of the mobile ad hoc network to a fixed network may increase fault tolerance by providing alternate routing paths. Supporting delay-sensitive traffic may include prioritizing delay sensitive traffic in the network. Prioritizing delay sensitive traffic may include providing priority queuing and priority channel access by differentiating data traffic across a protocol stack.

In embodiments, the present invention may provide remote monitoring, remote control, remote upgrade of the wireless mobile nodes, and the like; use location estimates among neighboring nodes to route traffic in the mobile ad hoc network; provide adaptive control of transmission power of a node based on location of the node; provide a connection of the mobile ad hoc network to a fixed network; prevent unauthorized network access to protect control-plane and user data; prevent users from exceeding authorized network usage through traffic shaping and policing; provide geo-location facilities within network nodes; and the like.

In embodiments, the present invention may enable at least partially wireless communications, including providing a mobile ad hoc network having a plurality of nodes, the nodes configured to self-route network traffic among the nodes, the nodes configured to use selectable parts of the telecommunications spectrum; and dynamically allocating use of the spectrum by a plurality of the nodes based on the condition of selectable parts of the spectrum, and the like. In addition, the present invention may facilitate adaptive control of the transmission power of a node based on the location of a node in the mobile ad hoc network.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts an embodiment of a mobile ad-hoc wireless network according to an embodiment of the present invention.

FIG. 2 depicts an embodiment of a wireless mesh network according to an embodiment of the present invention.

FIG. 3 depicts an embodiment of the use of dynamic spectrum access technology to wireless communication according to an embodiment of the present invention.

FIG. 4 depicts an embodiment of the mobile ad-hoc wireless network using dynamic spectrum access technology according to an embodiment of the present invention.

FIG. 5 depicts an embodiment for providing prioritization of delay-sensitive traffic across the network protocol stack in a mobile ad-hoc wireless network according to an embodiment of the present invention.

FIG. 6 depicts a graphical representative embodiment for providing network support for peer-to peer traffic in a MANET according to an embodiment of the present invention.

FIG. 7 depicts an embodiment for providing multiple fixed network gateway interfaces in a mobile ad-hoc wireless according to an embodiment of the present invention.

FIG. 8 depicts an embodiment for providing multicast routing in a mobile ad-hoc wireless according to an embodiment of the present invention.

FIG. 9 depicts an embodiment for providing remote network monitoring, control and upgrade in a mobile ad-hoc wireless network according to an embodiment of the present invention.

FIG. 10 depicts an embodiment for providing adaptive transmit power control in a mobile ad-hoc wireless network according to an embodiment of the present invention.

FIG. 11 depicts an embodiment for providing adaptive link data rate in a mobile ad-hoc wireless network according to an embodiment of the present invention.

FIG. 12 depicts an embodiment for providing location information of network nodes to neighboring nodes in a mobile ad-hoc wireless network according to an embodiment of the present invention.

FIG. 13 depicts an embodiment cross-layer architecture of the different algorithms and protocols that may enable carrier-grade operation.

FIG. 14 depicts an embodiment algorithmic flow of operation internal to an MBRI Node.

FIG. 15 depicts a ‘multi-hop’ relay embodiment including mobile nodes within network.

FIG. 16 depicts a flow diagram detail of a ‘multi-hop’ relay embodiment including mobile nodes within network.

While the invention has been described in connection with certain preferred embodiments, other embodiments would be understood by one of ordinary skill in the art and are encompassed herein.

All documents referenced herein are hereby incorporated by reference.

### DETAILED DESCRIPTION

The features of the present invention, which are believed to be novel, are set forth with particularity in the appended claims. The invention may best be understood by reference to the following description, taken in conjunction with the accompanying drawings.

While the specification concludes with the claims defining the features of the invention that are regarded as novel, it is believed that the invention will be better understood from a consideration of the following description in conjunction with the drawings figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an”, as used herein, are defined as one or more than one. The term “another”, as used herein, is defined as at least a second or more. The terms “including” and/or “having” as used herein, are defined as comprising (i.e. open transition). The term “coupled” or “operatively coupled” as used herein, is defined as connected, although not necessarily directly, and not necessarily mechanically.

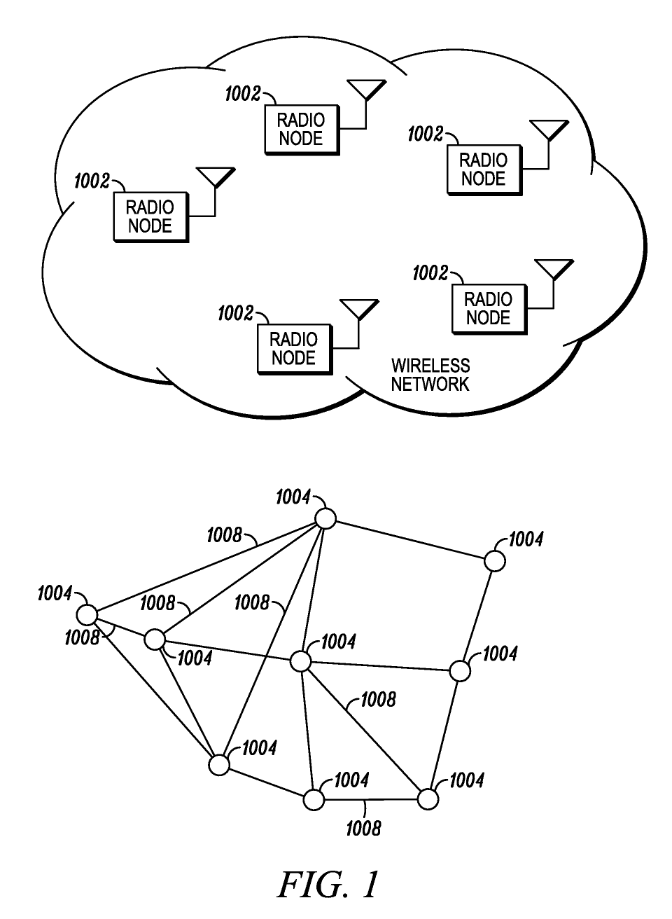

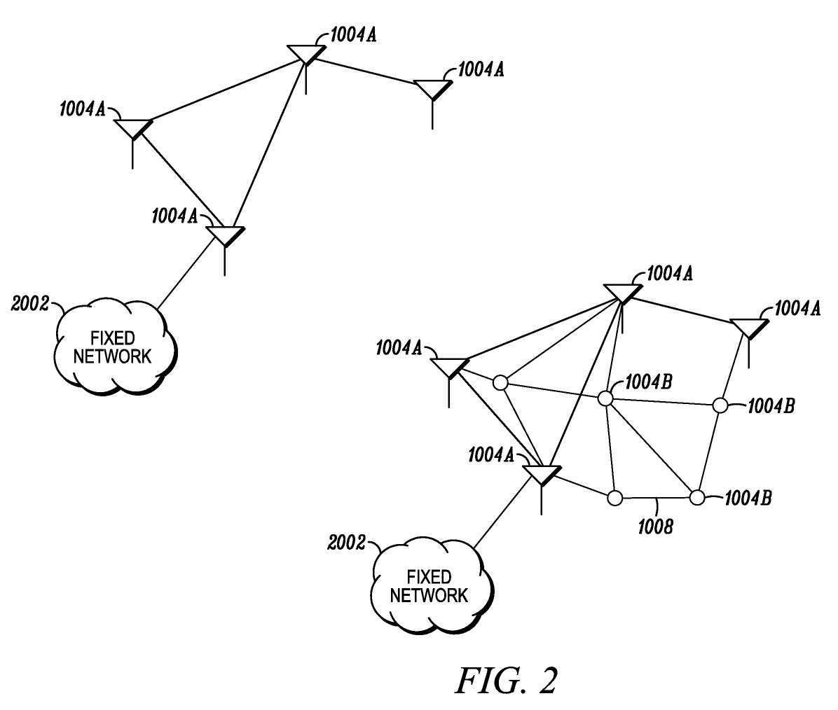

FIG. 1 illustrates a mobile ad-hoc wireless network according to an embodiment of the present invention. As shown in FIG. 1, the wireless network may have a set of wireless devices 1002 capable of communicating wirelessly. Each wireless device 1002 may be termed as a node 1004. A node 1004 may communicate with any other node 1004, and links 1008 may be formed between nodes 1004. The mobile ad-hoc network may include nodes 1004 that are mobile, as well as nodes 1004 that are fixed. In embodiments, the fixed nodes may enable the creating of a spanning network to establish initial wireless coverage across a geographic area. In addition, a subset of these nodes 1004 may have connectivity to a fixed (i.e., wired) network 2002, such as shown in FIG. 2. In a mobile ad-hoc wireless network, routing through the network may find the ‘best’ path to destination including ‘multi-hop’ relay across multiple wireless nodes 1004. The wireless network may be capable of autonomously forming and re-forming links 1008 and routes through the network. This dynamic forming and re-forming of links 1008 and routes may be made to adjust to changing conditions resulting from node mobility, environmental conditions, traffic loading, and the like. Thus, mobile ad-hoc wireless network's wireless topology may change rapidly and unpredictably.

Establishing a quality of service may be an essential quality for the mobile ad-hoc wireless network. In embodiments, quality of service for a mobile ad-hoc wireless network may be measured in terms of the amount of different types of data which the network successfully transfers from one place to another over a period of time. Some types of data may be considered higher priority than other types of data (e.g. due to latency requirements). Currently used mobile ad-hoc networks may have a number of issues with respect to network quality of service, such as application routing-focused communication without the ability to provide service-level agreements for quality-of-service, providing only unicast services, providing single power level only, providing a single data rate only, providing contention-based access (e.g., focus on inefficient unlicensed band radios), focused on military or public safety applications, congestion and dynamic and unpredictable latency (especially with multi-hop scenarios), and the like. In embodiments the present invention may provide for a mobile ad-hoc network that significantly improves on the shortcomings of current systems.

FIG. 2 illustrates a wireless mesh network according to an embodiment of the present invention. As shown in FIG. 2, the wireless mesh network may be a type of wireless ad-hoc network which allows multi-hop routing. A wireless mesh network architecture may sustain communications by breaking long distances into a series of shorter hops. The wireless mesh network may have a subset of nodes 1004 designated as access points 1004A to form a spanning network to establish initial wireless network coverage across a geographical area. In an embodiment, one or more access points 1004 may have a connection interface to a fixed network 2002. In embodiments, the fixed network 2002 that the access points 1004 connect to may be any known fixed network, such as the Internet, a LAN, a WAN, a cell network, and the like. As shown, a subset of nodes 1004 may be designated as ‘subscriber nodes’ 1004B that may form links 1008 among themselves and to the spanning network to augment wireless coverage. This may allow nodes 1004 connectivity to the fixed network 2002 via multiple hops across wireless topology. This topology may also change with node mobility. In embodiments, a wireless mesh network may be termed as a mobile ad-hoc network if the nodes 1004 in a wireless mesh network are mobile.

In embodiments, the mobile ad-hoc network may also provide a plurality of network services and attributes, such as autonomous neighbor discovery and maintenance, distributed network timing reference dissemination, dynamic frame structure, distributed scheduling with dynamic selection of scheduling algorithms (e.g., such as based on network topology, traffic load, spectrum availability), link-by-link autonomous data rate selection, traffic differentiation across the protocol stack (e.g. priority queuing and priority channel access), ARQ automatic repeat and request capability, geo-location capability for E-911 and location-based services, power control for intra-network interference management and spectrum reuse, unicast and multicast routing, interfacing in a standard way to existing IP core network nodes, encryption and authentication, OSS with EMS and NMS, and the like.

Currently dynamic spectrum access technologies may be focused on limited aspects of network performance, such as on TV bands, finding a single common slice of spectrum for the whole network, trying to avoid interference through power control, and the like. Dynamic spectrum access may provide spectrum used to communicate wirelessly between nodes changes in a non-pre-determined manner in response to changing network and spectrum conditions. In embodiments, the time scale of dynamics may be typically less than can be supported by engineering analysis, network re-planning, optimization, and the like. For instance, in response to manual or automated decisions, where there may be centralized decisions (e.g., network partitioning) or distributed local decisions of the individual nodes. Dynamic spectrum access may be able to avoid interference to/from geographically proximate spectrum users internal or external to their own wireless network. Dynamic spectrum access may also be able to access and utilize spectrum otherwise unavailable for wireless network use. In embodiments, local spectrum decisions may be coordinated and/or communicated using a fixed or logical control channel in an over-the-air wireless network.

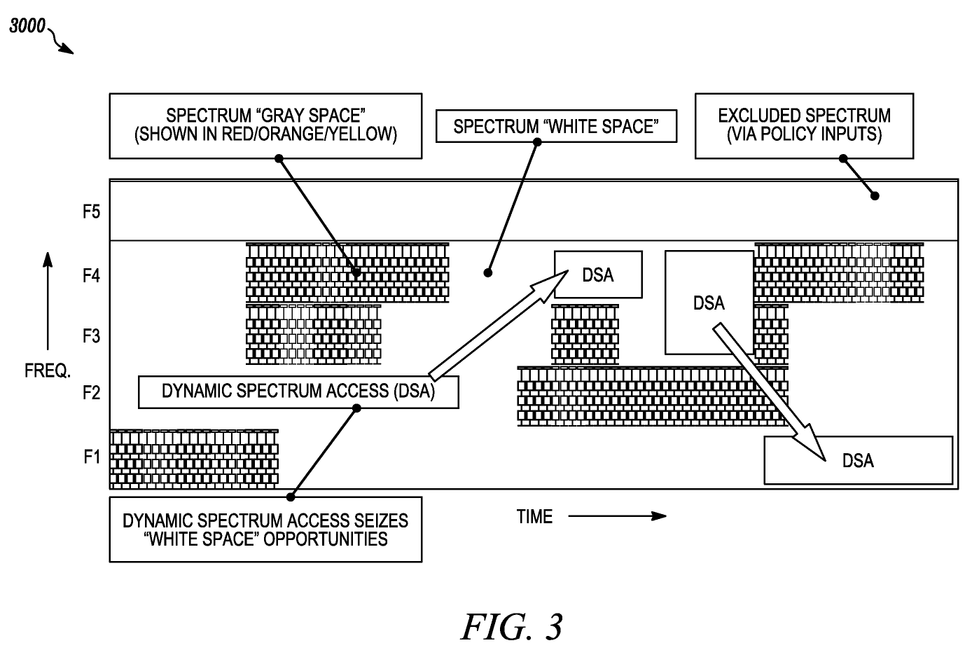

FIG. 3 illustrates the use of dynamic spectrum access technology 3000 to wireless communication according to an embodiment of the present invention. A wireless network may use dynamic spectrum access that provides a dynamic allocation of wireless spectrum to network nodes 1004. The spectrum may be used to communicate wirelessly between nodes 1004 in a non-pre-determined manner in response to changing network and spectrum conditions. Dynamic spectrum access technology may use the methodology of coordination of a collection of wireless nodes 1004 to adjust their use of the available RF spectrum. In embodiments, the spectrum may be allocated in response to manual or automated decisions. The spectrum may be allocated in a centralized manner (e.g., network partitioning) or in a distributed manner between individual nodes. The spectrum may be allocated dynamically such that interference to/from geographically proximate spectrum users internal or external to the wireless network may be avoided. The local spectrum decisions may be coordinated/communicated using a fixed or logical control channel in the over-the-air wireless network. This may increase the performance of wireless networks by intelligently distributing segments of available radio frequency spectrum to wireless nodes 1004. Dynamic spectrum access may provide an improvement to wireless communications and spectrum management in terms of spectrum access, capacity, planning requirements, ease of use, reliability, avoiding congestion, and the like.

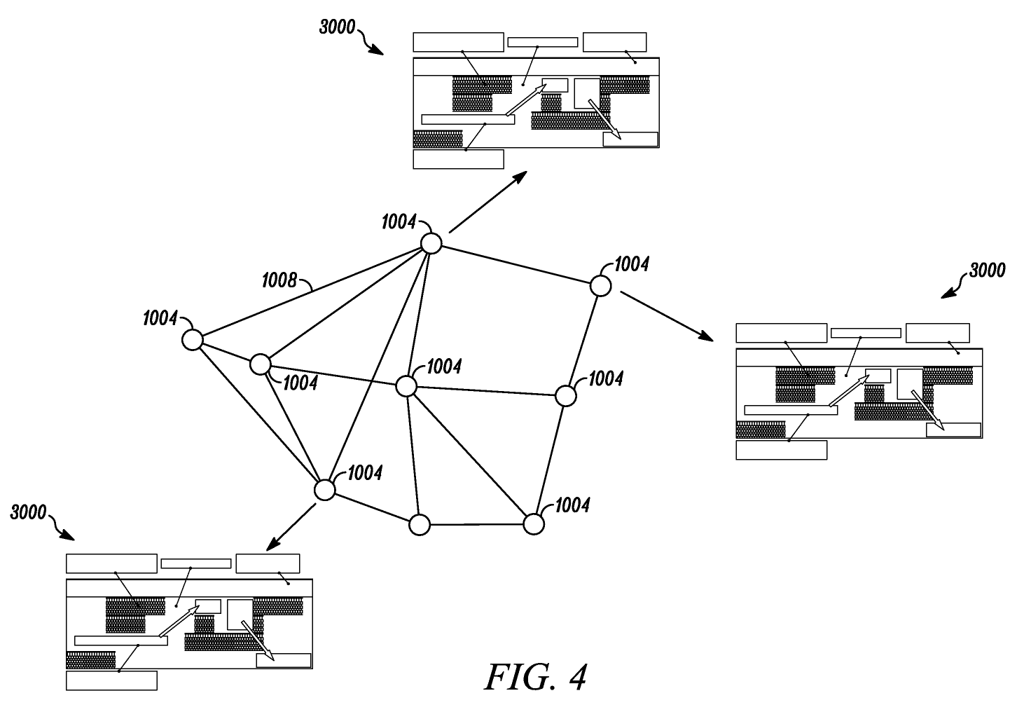

FIG. 4 illustrates a mobile ad-hoc wireless network using dynamic spectrum access technology 3000 according to an embodiment of the present invention. In this embodiment, a mobile ad-hoc wireless network may be used in conjunction with dynamic spectrum access technology 3000 to provide carrier grade quality of service. A collection of wireless nodes 1004 in a mobile ad-hoc network is shown dynamically adapting spectrum usage according to network and spectrum conditions. Individual nodes 1004 in the mobile ad-hoc wireless network may make distributed decisions regarding local spectrum usage. In embodiments, quality of service for a mobile ad-hoc wireless network may be measured in terms of the amount of data which the network may successfully transfer from one place to another in a given period of time, and dynamic spectrum access technology 3000 may provide this through greater utilization of the available spectrum. In embodiments, the dynamic spectrum access technology 3000 may provide a plurality of network services and attributes such as, coordinated and uncoordinated distributed frequency assignment, fixed or dynamic network coordination control channel, assisted spectrum awareness (knowledge of available spectrum), tunable aggressiveness for differing levels of co-existence with uncoordinated external networks, policy-driven for time-of-day frequency and geography, partitioning with coordinated external networks, integrated and/or external RF sensor, and the like.

In embodiments, the MBRI may provide enhancements that better enable carrier-grade service, such as through prioritization of latency-sensitive traffic across multiple layers of the networking protocols to reduce end-to-end latency and jitter (such as by providing priority queuing within node, priority channel access at MAC across nodes and priority routing across topology), providing network support for peer-to-peer connections bypassing network infrastructure, unicast and multicast routing with multiple gateway interfaces to fixed (i.e., wired) network, providing security to protect control-plane and user data and prevent unauthorized network access, traffic shaping and policing to prevent users from exceeding authorized network usage, remote monitoring, control, and upgrade of network devices, automatic re-transmission of loss-sensitive traffic, transparent link and route maintenance during periods of spectrum adaptation, rapid autonomous spectrum adaptation to maintain service quality, avoid interference, and maximize capacity, scalability of network protocols for reliable operation with node densities (e.g., hundreds to thousands of nodes per sq. km.) and node mobilities (e.g., to 100 mph) consistent with commercial wireless networks, using adaptive wireless network techniques to maximize scalable network capacity (e.g., adaptive transmit power control to reduce node interference footprint, adaptive link data rate, dynamic hybrid frame structure, dynamic distributed scheduling techniques, multi-channel operation using sub-channels and super-channels, load-leveling routing), simultaneous support of multiple broadband, high mobility network subscribers, interfaces with fixed carrier network (e.g., to support VoIP, SIP, etc.), and the like.

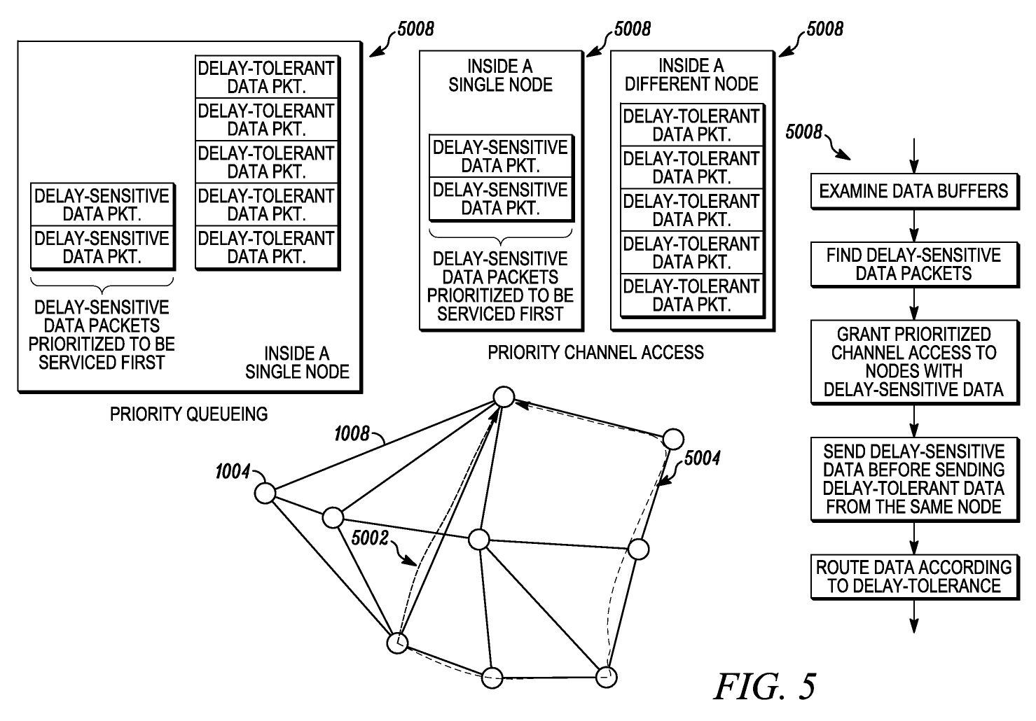

In embodiments, an enhancement may be prioritization. FIG. 5 illustrates a method of providing prioritization of delay-sensitive traffic 5002 across the network protocol stack in a mobile ad-hoc wireless network according to an embodiment of the present invention. As shown, the prioritization of delay-sensitive traffic 5002 may be done by granting prioritized channel access to nodes with delay-sensitive data 5002 and sending the delay-sensitive data 5002 before sending the delay-tolerant data 5004 from the same node. This may enable the provision of service level performance agreements. FIG. 5 also shows a number of traffic flow diagrams 5008 that help illustrate prioritization of delay-sensitive traffic 5002 and delay-tolerant traffic 5004 though the network of the present invention.

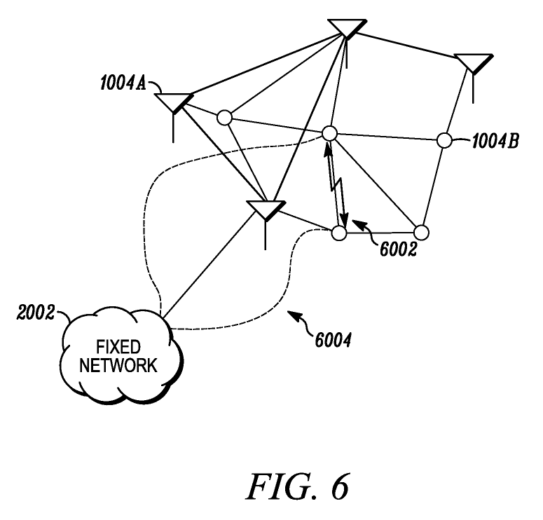

In embodiments, an enhancement may be network support for peer-to-peer traffic. FIG. 6 illustrates a method of providing network support for peer-to peer traffic 6002 in a mobile ad-hoc wireless network according to an embodiment of the present invention. Providing network support for peer-to-peer traffic 6002 without forcing routing through the fixed network in a network-infrastructure communication path 6004 may decrease the amount of wireless network capacity required to deliver service. This may allow the network to offer more service with the same amount of capacity.

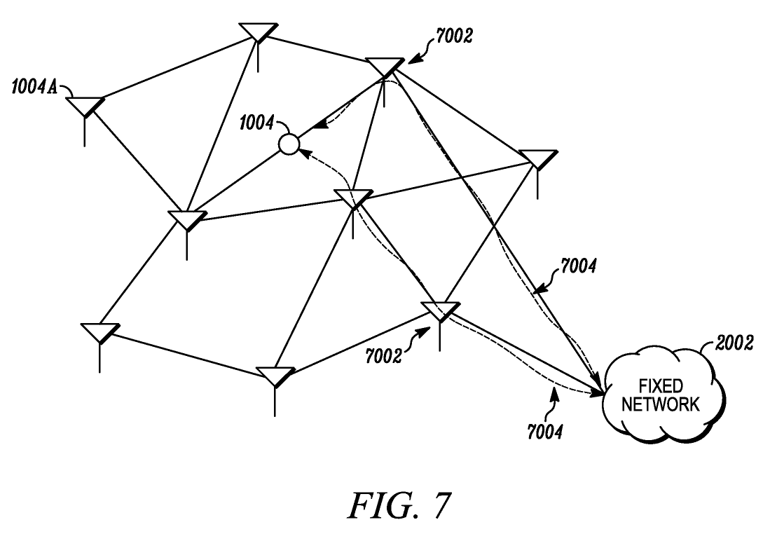

In embodiments, an enhancement may be multiple fixed network gateway interfaces 7002. FIG. 7 illustrates providing multiple fixed network gateway interfaces 7002 in a mobile ad-hoc wireless according to an embodiment of the present invention. In this embodiment, multiple connections to the fixed network 7004 may enable backhaul load leveling, and increases fault-tolerance by providing alternate routing paths to a node 1004.

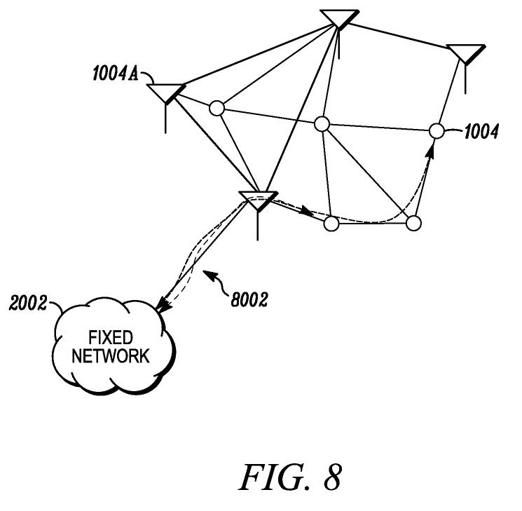

In embodiments, an enhancement may be multicast routing. FIG. 8 illustrates providing multicast routing in a mobile ad-hoc wireless according to an embodiment of the present invention. In this embodiment, multicast routing 8002 may improve efficiency of network capacity by avoiding multiple transmissions of common data along a common path. This may allow the network to offer more service with the same capacity.

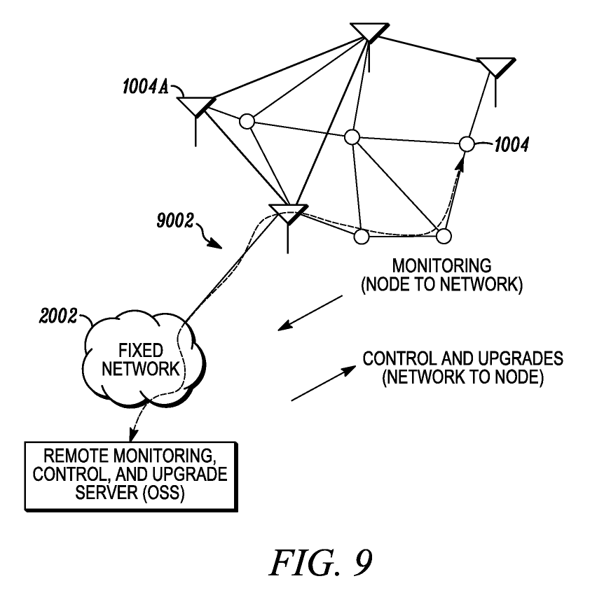

In embodiments, an enhancement may be remote network monitoring, control, and upgrade. FIG. 9 illustrates providing remote network monitoring 9002, control and upgrade in a mobile ad-hoc wireless network according to an embodiment of the present invention. In this embodiment, remote monitoring of network elements may enable proactive and reactive network maintenance. Remote control may enable reduced cost network upgrades and tuning. Remote upgrade may dramatically reduce labor content of network-wide upgrade.

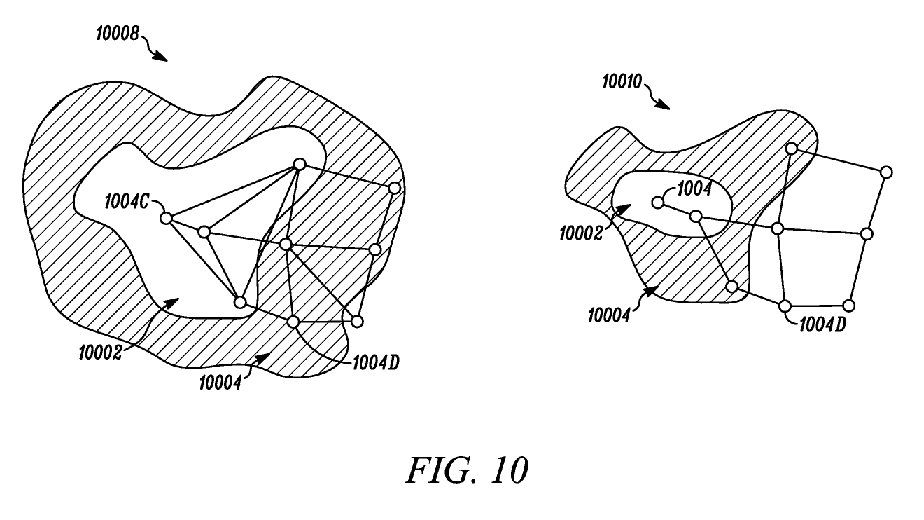

In embodiments, the present invention may include adaptive transmit power control. For instance, a MANET may provide transmissions that may typically occur at a fixed transmit power. The slot capacity may depend on the modulation, coding, bandwidth, and TDMA time slot duration. A link exists if two nodes are within direct communications range of one another. These nodes are called one-hop neighbors. Similarly, a collection of nodes within two hops of a node form its two-hop neighborhood. The two-hop neighborhood may be an important concept for some channel access scheduling algorithms. These channel access scheduling algorithms may coordinate the transmissions considering all nodes in the two-hop neighborhood. Nodes outside the two-hop neighborhood may be scheduled independently. On average, a node may transmit proportionally once for every N2 slots where N2 is the number of nodes in the two-hop neighborhood. Hence, the smaller the two-hop neighborhood, the more often each node can transmit, resulting in increased network capacity. Adjusting the transmit power can be an effective way to reduce the size of the two-hop neighborhood. This concept is illustrated in FIG. 10 where the connectivity zone 10002 and the interference zone 10004 are shown for full power 10008 (left) and reduced power 10010 (right). In embodiments, adaptive transmit power control may reduce the area where the node 1004C causes interference to other nodes 1004D.

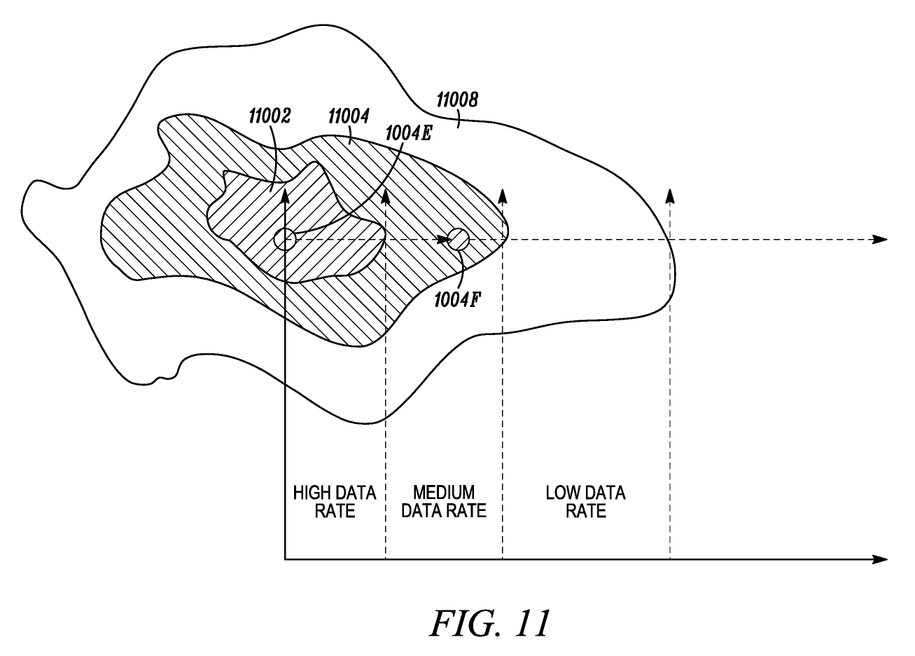

In embodiments, the present invention may include adaptive data rate (ADR). For instance, a MANET may autonomously discover links between neighboring nodes in order to exchange data over the network. Initial link establishment may occur using a fixed data rate. Links may be established when two nodes are within communications range of one another. The data rate that can be supported over a link may be roughly proportional to the distance between the transmitter and receiver, as determined by the path loss. Over shorter links (i.e., smaller path loss), increased data rates can be supported. In a cellular network, mobile nodes always communicate only with a base station. This allows the base station to act as a central controller for adjusting the link data rates for the nodes it is communicating with. In a MANET, all nodes may be able to communicate with all other nodes, and there may be no centralized controller. A distributed protocol may be needed to adjust link rates. Once neighbors are discovered and links established, an ADR adjustment algorithm may adjust the data rate on the link to the maximum rate that can be reliably sustained (i.e., low slot error rate) based on link conditions. FIG. 11 shows a depiction of how different data rates may be supported for different link conditions (e.g., range and blockage) based on relative node locations. The circles indicate two nodes 1004 in a MANET. The shaded areas indicate the nominal locations where different data rates can be supported between the left-most node 1004E and any other node 1004F in the MANET. The darker shaded areas indicate higher data rate 11002 that can be supported. For example, in a network with three available data rates, suppose the right-most node 1004F is traveling along the dotted line path (to the right) away from the left-most node 1004E. When the two nodes are nearby, a “high data rate” can be supported. As the node 1004F moves away, a “medium data rate” 11004 can be supported as shown in the FIG. 11. With continued motion, a “low data rate” 11008 is supported. At distances beyond where the low data rate 11008 can be supported, the link is dropped and a multi-hop route through the MANET is needed to exchange data between the nodes.

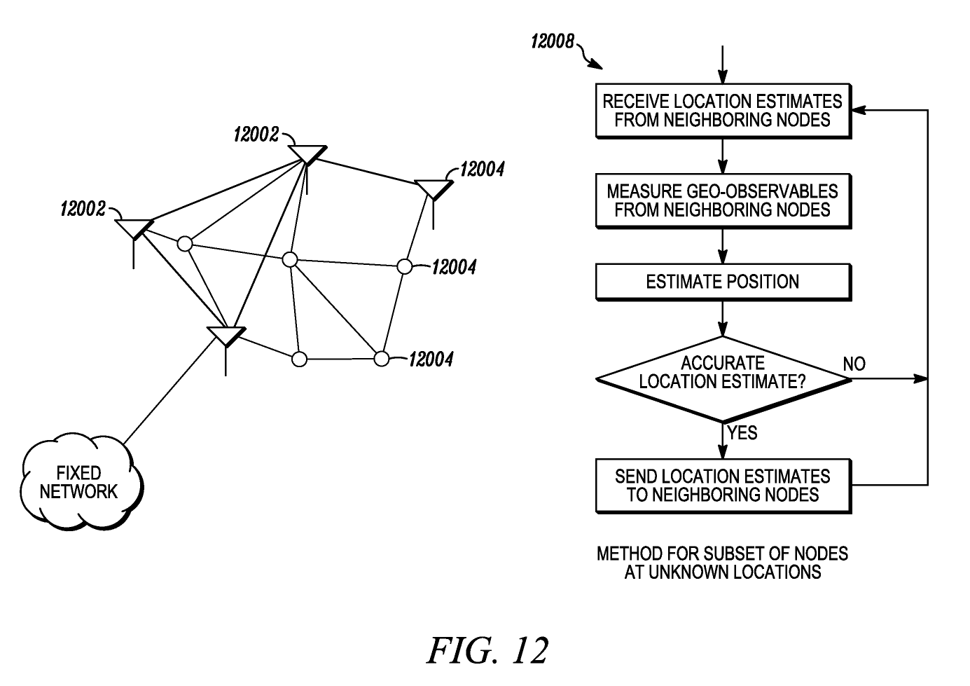

In embodiments, an enhancement may be network geo-location. FIG. 12 illustrates providing location information of network nodes to neighboring nodes in a mobile ad-hoc wireless network according to an embodiment of the present invention, such as amongst nodes of a known location 12002 and nodes of an unknown location 12004 (e.g. mobile nodes). FIG. 12 also provides an embodiment node location flow diagram 12008 to illustrate how nodes may share location information with neighboring nodes. In this embodiment, providing geo-location of network nodes to the neighboring nodes may facilitate public safety and may enable location-based services.

In embodiments, the benefits of the present invention may include increased network capacity, increased ease of network deployment, increased network reliability, decreased overall network cost, and the like. For instance, increased network capacity may include autonomous link rate selection to maximize individual link and network-wide data rates, increased access to otherwise unused spectrum increasing raw network capacity, improved network scalability (e.g. adding users to network increasing total network capacity), increased range of differentiated service offerings (including delay-sensitive and delay-tolerant applications), more efficient servicing of peer-to-peer network traffic, and the like. Increased ease of network deployment may include dramatically reduced frequency planning, dramatically reduced site requirements, dramatically reduced site planning, reduced labor installation costs (e.g. smaller devices, reduced site requirements, and simplified provisioning), increased robustness in challenging RF multipath environments, seamless operation inside and outside of buildings, connect to fixed backhaul when and where it is available using any common network interface rather than requiring backhaul at a specific ‘advantaged’ site, increased responsiveness to changes in network usage, autonomous adaptation to network expansion and upgrades (e.g. on geographic edge of the network, or increased node density within existing coverage area), network-wide upgrades via software, transparent integration with other networks in the same spectrum bands, and the like. Increased network reliability may include increased fault-tolerance, self-forming and self-healing to network infrastructure outages (may eliminate the need for 1:1 or N:1 redundancy), graceful degradation during periods of network congestion, improved geo-location performance relative to cellular due to higher node density, OSS monitoring of network faults, and the like.

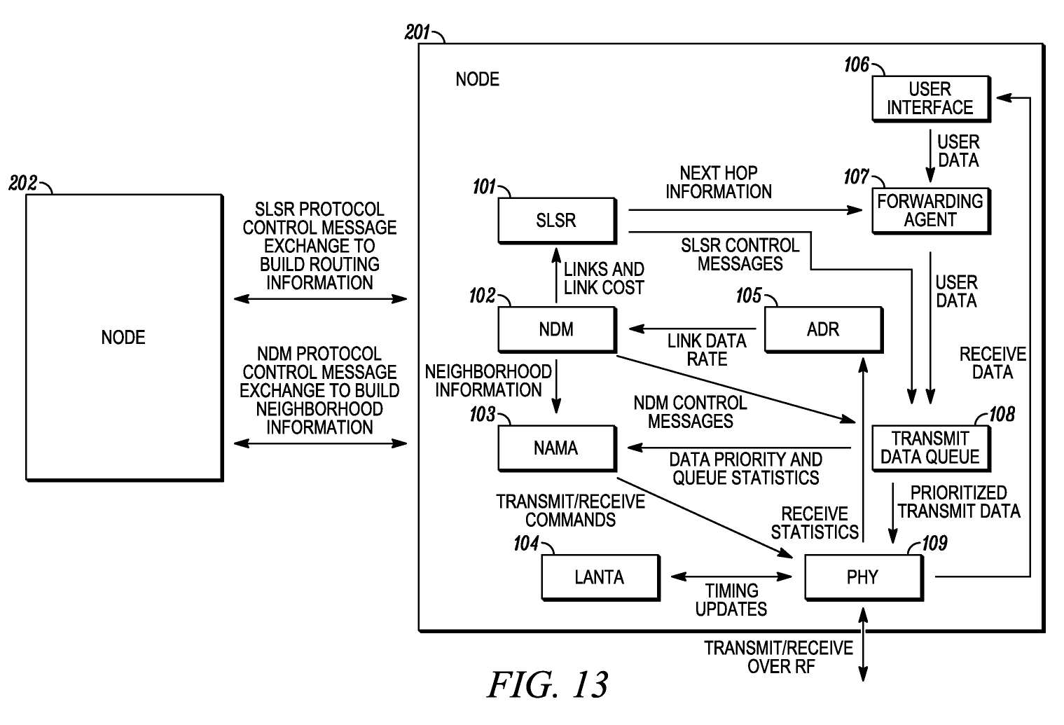

FIG. 13 depicts an embodiment cross-layer architecture of the different algorithms and protocols that may enable carrier-grade operation. The different algorithms and protocols (i.e., modules) may communicate with each other in two ways as follows: 1.) between modules internal to a radio node and 2.) between the corresponding modules across different radio nodes. Internal node communications may occur directly between the indicated blocks, and communications protocol messages between modules (e.g., SLSR, NDM) generate control packets that are exchanged through transmission and reception over the RF interface. In FIG. 13, the Node 201 exchanges protocol messages with Node 202. The SLSR control messages may be used to exchange routing information, and the NDM control messages may be used to build and maintain local neighborhood information about the MANET topology. Internal to Node 201, the following modules may exchange internal information. SLSR (Scoped Link-State Routing) 101 functionality may be responsible for maintaining knowledge of MBRI network topology and appropriate next hop for reaching other MBRI nodes and the fixed network interface. NDM (Neighbor Discovery and Maintenance) 102 functionality may be responsible for maintaining knowledge of one-hop and two-hop MBRI neighbors and the status of their need for priority access to network bandwidth. NAMA (Node Activated Multiple Access) 103 functionality may be responsible for interpreting local MBRI neighborhood topology and generating a transmit/receive schedule for every TDMA time slot that enables prioritized access to network bandwidth (vs. contention-based methods such as those found in 802.11). LANTA (Local Area Network Time Algorithm) 104 functionality may be responsible for adjusting local time clock and frequency reference to account for time and frequency drift in nodes without strict time discipline. ADR (Adaptive Data Rate) 105 functionality may be responsible for adjusting the transmit data rate over each MBRI link to the maximum rate that is reliably sustainable for the RF conditions of the link. User Interface 106 functionality may be the node interface with the user application (e.g., VoIP, Video, internet data, etc.). Forwarding Agent 107 functionality may be responsible for implementing the next hop forwarding decisions of SLSR to route user data to its intended destination. Transmit Data Queue 108 functionality may be responsible for queuing up data in priority order for transmission to allow differentiated Service Level Agreements (SLAs) for differing data types. PHY 109 functionality may be responsible for data transmission and reception over RF and generation of receive statistics (e.g., slot error rate, received signal strength, etc.).

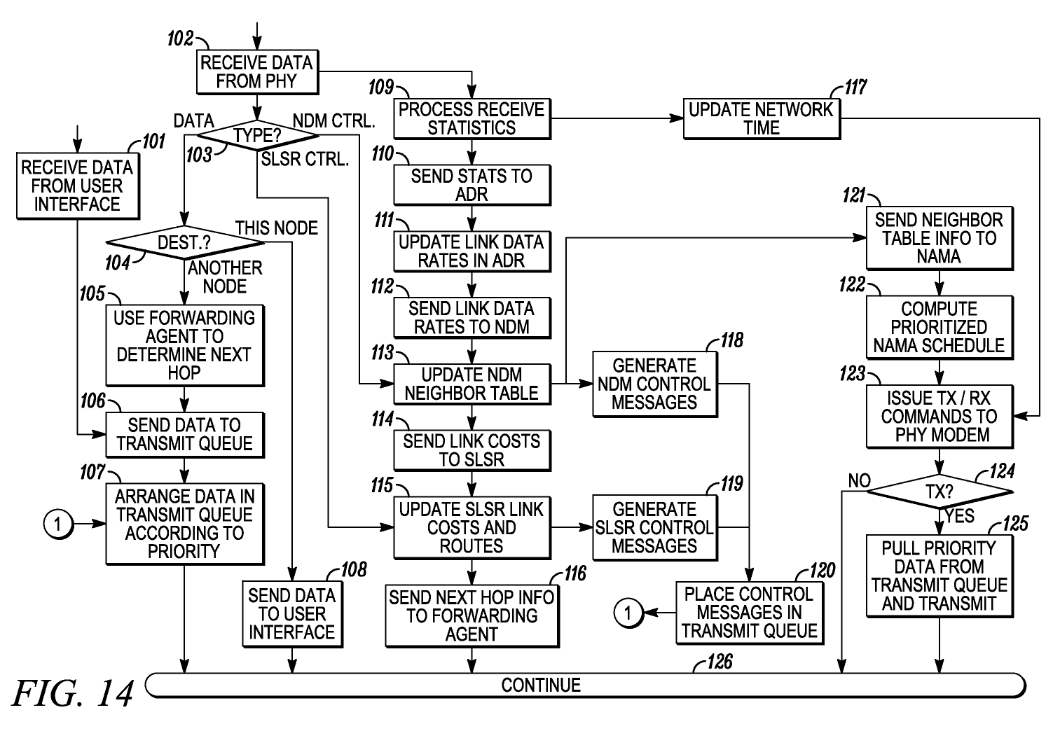

An embodiment of an algorithmic flow of operation internal to an MBRI Node is depicted in FIG. 14 for the Node Architecture shown in FIG. 13. The multiple algorithms and protocols (i.e., modules) may interwork to continually provide updates to each other containing the latest available information regarding network status. One skilled in the art would appreciate that this is but one embodiment of an algorithmic flow of operation, and that other flow embodiments may be implemented as representative of the present invention.

In embodiments, when user data is present at the Node, it is received from the user interface (101) and sent to the transmit queue 106. Once in the queue, the data may be arranged in priority order so that differentiated access may be provided 107.

In embodiments, when the PHY (i.e., modem) receives data across the RF interface 102, the type of data contained in the burst is first determined 103. If the data is user data, it is inspected to determine whether it is intended for delivery at this node or another node 104. Data intended for this node is sent to the user interface 108. When data is intended for another node (i.e., relay), the next hop is determined via the Forwarding Agent 105 and is placed on the transmit queue 106. Transmit queue data may be re-arranged according to priority 107. When the type of data received is an NDM Control Message, it may be used to update the NDM Neighbor Table 113. When it is an SLSR Control Message, it may be used to update the SLSR link and route information 115.

The PHY receive data may be continually monitored and statistics are generated 109. The LANTA algorithm may be used to update the node's view of network time and correct local oscillator frequency drift 117. Corrected time and frequency offsets may be fed to the PHY 123. The receive statistics processed at 109 may be sent to the ADR module 110 and used to update the link data rates 111. The updated link data rates may be sent to NDM to update the NDM Neighbor Table 113. NDM may send the link costs to SLSR 114 where the routes are updated 115. The Next Hop information determined by SLSR may be send to the Forwarding Agent 116. Both NDM and SLSR may generate control messages 118 and 119 and place these messages in the Transmit Queue 120. These messages may then be re-sorted as part of the queue prioritization scheme in 107.

The NDM Neighbor Table updates in 113 may sent to NAMA 121 for computing the prioritized NAMA schedule 122. The computed schedule may issue transmit and receive commands to the PHY/modem 123. Block 124 may interpret the schedule and when a transmission is indicated, pull the priority data from the transmit queue and transmit it over the wireless interface 124.

At the conclusion of each flow branch, the process may continue 126, adapting to changes in network conditions while maintaining multimedia carrier-grade service delivery with prioritization of critical data across the communications protocol stack.

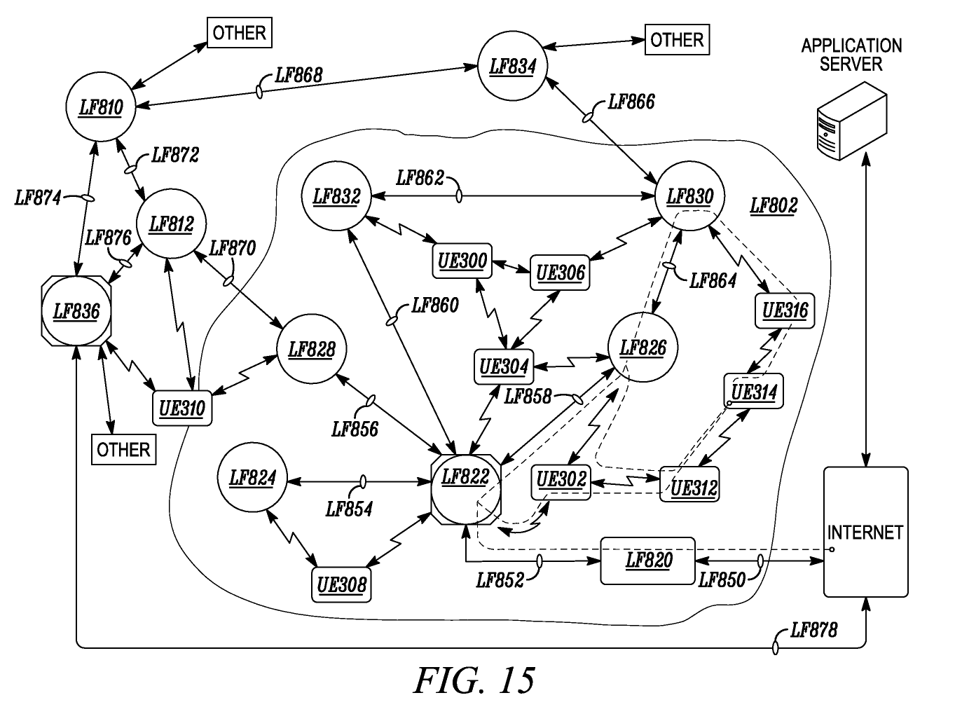

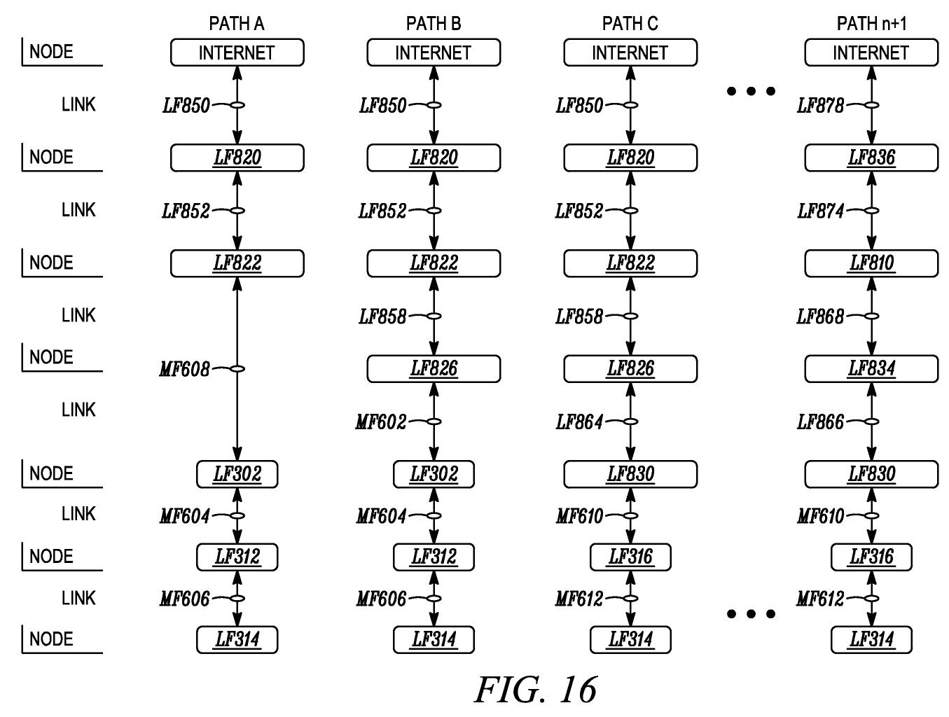

FIG. 15 and FIG. 16 together provide an embodiment of how a node configuration may implement communications across the network of the present invention; where FIG. 15 provides a node layout interrelationship, and FIG. 16 provides a number of flow diagrams as example communication flows through the nodes depicted in FIG. 15. For example, Path A, whose flow diagram is depicted in FIG. 16, shows packet data entering from the Internet, as depicted in FIG. 15, traversing a backhaul access point (BAP) node LF820, to a MBRI access point (MAP) node LF822, to a subscriber device node UE302, to a subscriber device node UE312 to the final destination subscriber device node UE314.

While this is happening at the routing layer (SLSR) may maintain IP routing transparency with the Internet by exchanging link status information for all the links in path A and for all nodes that UE314 can reach within the network (arcs LF862, LF860, LF858, LF 864, LF 852, LF850, LF 856, LF 854, LF870, LF876, LF874, LF 878, LF866, LF 868). Link costs may be related to the power requirement for transmission, relative hop count, modulation mode and physical metrics read from the neighbor tables including signal to noise ratios, received signal strength indicator levels, slot error rate and other RF measures, and the like.

In parallel in the one hop and two hop neighborhood of UE314, the Neighbor Discovery & Management (NDM) protocol may update neighbor information via data link control messages, see the path UE314, UE312, LF830, UE316 and UE302. In addition, the one hop and two neighbors of the effected path may also be updated such as LF826, UE304 etc. NDM also may provide for Node Entry i.e. new nodes starting up and for Node Exit i.e. nodes that terminate. Link costs are adjusted accordingly by NDM working with SLSR to advertise link costs to other BAP and MAP nodes.

The Node Activation Multiple Access (NAMA) protocol may schedule slots for transmission and reception between UE314 and UE312 and between UE314 and UE316 in such a way to avoid timeslot collisions occurring at UE314. Slot scheduling may be happening concurrently for all paths in the network on a per time slot basis. These slots may be separable in time and frequency at the physical layer under the control of NAMA.

In addition, the Receiver Oriented Multiple Access (ROMA) link scheduling algorithm may determine the least amount of interference for path A by examining the “interference footprint” of all possible paths to send data to or receive data from UE314 between UE314 and the Internet including path B, path C, etc., such as shown in FIG. 15.

When a route is selected, such as path A, the Adaptive Data Rate (ADR) algorithm may ensure that the highest modulation rate is selected for each hop in the path. ADR may work with NAMA and ROMA to ensure the route with the least interference and the highest quality slots are used for transmission purposes between nodes and for an entire path route.

At the physical layer all nodes in all paths may receive time synchronization data within the data link control messages which also may carry NDM statistics data, NAMA and ROMA information, and the like. Each node may use a Local Area Node Tracking Algorithm LANTA to calculate its offset and time differential from GPS source time e.g. LF 822 (spanning MAP) maintains GPS reference time and therefore one hop and two hop neighbors UE302 and UE312 can maintain time differentials and disseminate that data to their neighbors, and triangulation can be used to maintain relative time offsets accurately enough for peer to peer slot scheduling and transceiver operations.

Note that additional algorithms such as dynamic spectrum awareness for minimum spectral footprint, transmit power control and tunable aggressiveness may affect the size of the one hop and two hop neighborhoods and help to streamline how NDM information is promulgated and used in the NAMA and ROMA algorithms for channel access and slot contention.

Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention.

The methods and systems described herein may be deployed in part or in whole through a machine that executes computer software, program codes, and/or instructions on a processor. The present invention may be implemented as a method on the machine, as a system or apparatus as part of or in relation to the machine, or as a computer program product embodied in a computer readable medium executing on one or more of the machines. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A computer program product embodied in a computer readable medium that, when executing on one or more computers, operates a mobile ad hoc network by performing the steps of:
forming a mobile ad hoc network having a plurality of wireless communication links connecting a plurality of wireless mobile nodes;
applying a dynamic spectrum awareness algorithm to facilitate effective utilization of the available communications spectrum in an environment of the mobile ad hoc network;
supporting both delay-sensitive and delay-tolerant traffic types on the mobile ad hoc network; and
providing a defined quality of communications service for both the delay-sensitive and the delay-tolerant traffic.

2. The computer program product of claim 1, wherein communication is provided through link-by-link autonomous data rate selection.

3. The computer program product of claim 1, wherein communication is provided through unicast and multicast routing of data through the network.

4. The computer program product of claim 1, wherein communication is provided through peer-to-peer connections to selectively bypass fixed communications network infrastructure.

5. The computer program product of claim 1, further comprising providing at least one of remote monitoring, remote control, and remote upgrade of the wireless mobile nodes.

6. The computer program product of claim 1, further comprising using location estimates among neighboring nodes to route traffic in the mobile ad hoc network.

7. The computer program product of claim 1, further comprising providing adaptive control of transmission power of a node based on location of the node.

8. The computer program product of claim 1, wherein communication is provided through dynamically adapting spectrum usage according to network and spectrum conditions.

9. The computer program product of claim 8, wherein dynamically adapting spectrum usage according to network and spectrum conditions comprises making distributed decisions regarding local spectrum usage by individual wireless nodes.

10. The computer program product of claim 1, further comprising providing a connection of the mobile ad hoc network to a fixed network.

11. The computer program product of claim 10, wherein the connection of the mobile ad hoc network to a fixed network enables backhaul load leveling.

12. The computer program product of claim 10, wherein the connection of the mobile ad hoc network to a fixed network increases fault tolerance by providing alternate routing paths.

13. The computer program product of claim 1, wherein communication is provided through enabling automatic re-transmission of loss-sensitive traffic.

14. The computer program product of claim 1, wherein supporting delay-sensitive traffic includes prioritizing delay sensitive traffic in the network.

15. The computer program product of claim 14, wherein prioritizing delay sensitive traffic comprises providing priority queuing and priority channel access by differentiating data traffic across a protocol stack.

16. The computer program product of claim 1, further comprising preventing unauthorized network access to protect control-plane and user data.

17. The computer program product of claim 1, further comprising preventing users from exceeding authorized network usage through traffic shaping and policing.

18. The computer program product of claim 1, wherein communication is provided through transparent link and route maintenance during periods of spectrum adaptation.

19. The computer program product of claim 1, wherein communication is provided through scalability of network protocols for reliable operation with node densities and node mobilities of commercial wireless networks.

20. The computer program product of claim 1, further comprising providing geo-location facilities within network nodes.

21. A computer program product embodied in a computer readable medium that, when executing on one or more computers, enables at least partially wireless communications, comprising:
providing a mobile ad hoc network having a plurality of nodes, the nodes configured to self-route network traffic among the nodes, the nodes configured to use selectable parts of the telecommunications spectrum; and
dynamically allocating use of the spectrum by a plurality of the nodes based on the condition of selectable parts of the spectrum.

22. The computer program product of claim 21, further comprising facilitating adaptive control of the transmission power of a node based on the location of a node in the mobile ad hoc network.
